(19) United States
(12) Patent Application Publication
(10) Pub. No.: US 2001/0040589 A1
(43) Pub. Date: Nov. 15, 2001

(54) User interface for the processing and presentation of image data

(76) Inventors: Hubrecht Lambertus Tjalling De Bliek, Eindhoven (NL); Bert Leo Alfons Verdonck, Eindhoven (NL); Marcel Breeuwer, Eindhoven (NL)

Correspondence Address: Corporate Patent Counsel, U.S. Philips Corporation, 580 White Plains Road, Tarrytown, NY, 10591, US

(21) Appl. No.: 09/801,626

(22) Filed: Mar. 8, 2001

(30) Foreign Application Priority Data
Mar. 9, 2000 (EP) 00200854.8

(51) Int. Cl. G06F 3/00

(52) U.S. Cl. 345/700; 345/764

(57) ABSTRACT

The invention relates to a workstation provided with an interface for the processing of sets of diagnostic images. The diagnostic images may have been generated by various diagnostic imaging modalities such as X-ray, CT, MRI, ultrasound etc. Various image processing applications can be applied to each set of diagnostic images. For each set of diagnostic images there is formed a representative pictorial (small image showing coarse details only) is formed and displayed. Furthermore, a set of attributes is assigned to the respective sets of images. Such attributes determine the image processing applications that are feasible for the set of diagnostic images at issue. The applicable image processing applications are displayed together with each pictorial. Preferably, the combinations of applicable image processing applications and the pictorial are displayed in a tab-page structure which corresponds to the workflow in the relevant hospital department.

The invention relates to a user interface for the processing and presentation of image data, notably medical image data, which interface is arranged to co-operate with a database containing the image data, and a visual display unit and an input member that serves for communication with a user.

A (software) user interface of this kind is known from practice and forms part of a medical analysis system which includes a computer, a visual display unit that is coupled to the computer and also an input member; such a system is customarily used by medical specialists for diagnosis, treatment and the like. Usually different types of medical image data are acquired during the medical diagnostic process. Such data may be acquired, for example by means of magnetic resonance but may also originate from computed tomography, ultrasound or X-ray images. In practice the image data is subjected to various operations or presentations; a problem is then encountered in that the selection of the available image data and the image processing operations to be performed thereon are not optimally structured in the known device. It is an object of the invention to improve this situation and to realize also further advantages as will become apparent hereinafter.

The user interface in accordance with the invention is characterized in that for each group of coherent image data of the database the interface performs an image selection so as to present this selection to the display unit. The user is thus offered a readily accessible survey of the available image data that can be processed. The image data is usually combined with attribute data which is stored in the database and characterizes a patient and/or said image data.

According to a further aspect of the invention the interface selects, in dependence on the attribute data, feasible applications for each group of coherent image data and separately adds a reference to every selected application to the image selection associated with the group of coherent image data for which the relevant application has been selected. This substantially simplifies the choice to be made by the user in respect of the operations to be performed on a group of coherent image data.

The user interface is advantageously arranged in such a manner that, if necessary, a user can add a selected application to an image selection. A very effective and transparent method of operation is achieved by means of an embodiment of the user interface in accordance with the invention which is characterized in that it displays the feasible applications on the display unit and that, after selection of an application by a user, the interface performs a selection of every group of coherent image data that can be processed by the selected application and presents only the image selections that characterize this image data to the display unit.

In a further version of this embodiment it is useful that the interface shows the feasible sub-functions for each application and that each of these sub-functions can be individually selected by a user.

According to another aspect of the invention the user interface is characterized in that the applications and/or sub-functions are adjustable in a desired processing order. This order may be pre-selected or be changed by the user in order to conform with conventions prevailing in the relevant medical examination environment.

The invention is also embodied in a medical analysis system that is provided with a user interface of the kind set forth.

The invention will be described in detail hereinafter, by way of non-limitative example, with reference to the accompanying figures.

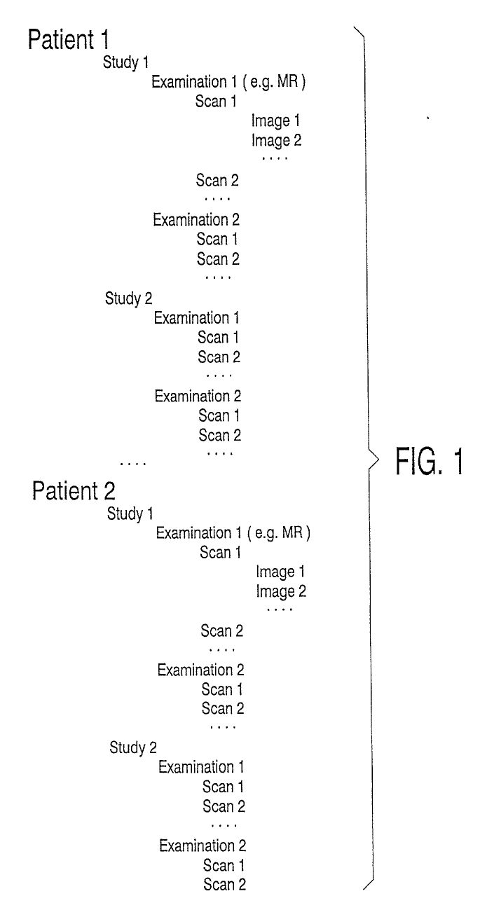

FIG. 1 shows an example of the structure of the database wherefrom the image data is extracted.

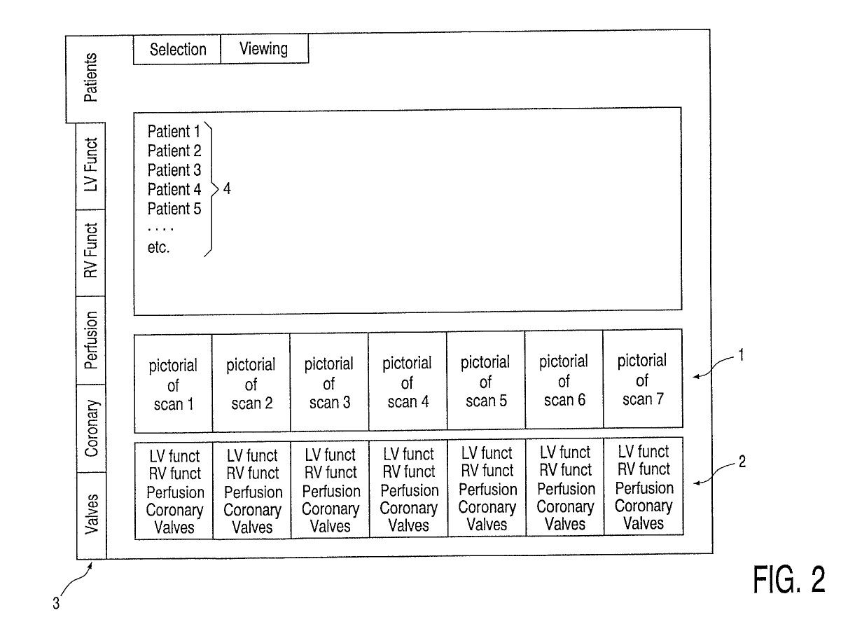

FIG. 2 shows a feasible image displayed on the visual display unit by the user interface.

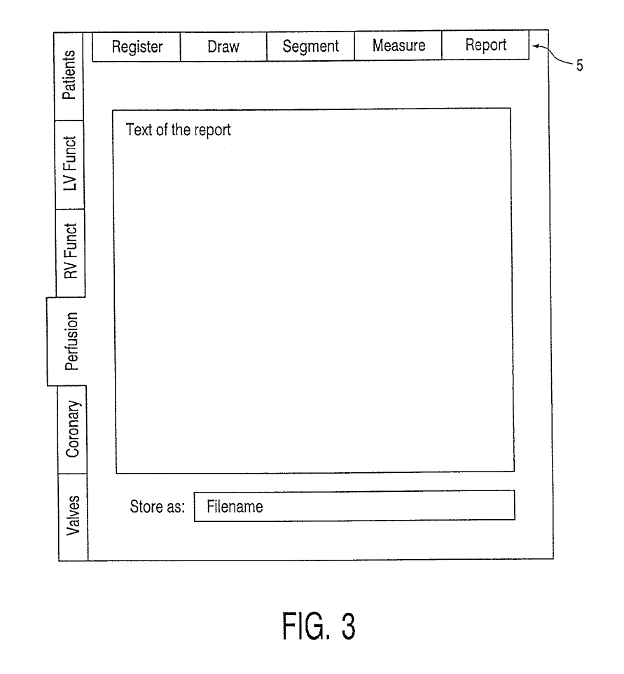

FIG. 3 shows sub-functions that are displayed on the visual display unit after selection of a feasible application.

Referring first to FIG. 1, the structure of the database will be described in relation to two patients. For both patients 1 and 2 various studies may have been performed, for example the study 1 and the study 2. Each study is composed of one or more examinations which may be understood, for example, as a magnetic resonance scan. Each individual scan is stored and is composed of so-called time-sequential images or location-sequential images, indicated as the image 1, the image 2, etc. Attribute data that characterizes the various parts are stored for each patient as well as for each individual study, examination and scan. This attribute data is instrumental in the selection of the feasible applications that can be applied to the relevant image data contained in the respective scans. The attribute data is also instrumental in the determination of the method of display of the selected images in the various applications that can be applied to said images. For example, in a viewing application a series of time-sequential images, will be reproduced directly as a film while, for example, all images of a series of location-sequential images will be individually reproduced as pictorials.

Reference is now made to FIG. 2 which shows a row of adjacently depicted image selections at the level of the arrow 1. Each image selection corresponds to a group of coherent image data as stored per scan. Underneath this row 1 of image selections or pictorials there are indicated feasible applications for each image selection individually, that is, at the level of the row denoted by the arrow 2. According to the example shown each time all feasible applications are shown, the applications that are feasible for the relevant group of coherent image data being reproduced in heavy print. The interface performs the selection of said feasible applications in such a manner that they are determined while utilizing the previously mentioned attribute data (see description given with reference to FIG. 1). The same applications are also shown in the column 3, that is, at the left in the Figure. When a user of the interface selects the application “valves” in the situation shown, the user interface changes the image displayed on the visual display unit in such a manner that only the image selections or pictorials remain for which this application is feasible. In the case shown these are the image selections of the scan 4 and the scan 5. Referring to FIG. 2 it is also to be noted that in the situation shown the application “patients” has been selected, notably patient number 3, as is reproduced in heavy print in the patient list 4. The image selections shown in the row relate exclusively to the selected patient number 3.

FIG. 3 shows an image that may become available after selection of the application “perfusion”. The reference numeral 5 refers to a row of sub-functions that are associated with the application “perfusion” and can subsequently be selected by a user. It is to be noted that the various applications 3 (see FIG. 2) and sub-functions 5 (see FIG. 3) can be adjusted in any desired processing order so as to be compatible with a desired method of operation as it may be imposed in a specific hospital environment.

To those skilled in the art it will be evident that the above example concerns only one of many versions that are feasible within the context of the invention. The example described above merely serves to illustrate the claims hereinafter and in conformity therewith the extent of the protection that is due to the invention is defined exclusively by the claims hereinafter.

In order to illustrate the feasible applications and sub-functions that are involved in cardiac functions, reference is made to the following table which states the feasible applications at the left in heavy print and therebelow each time the associated sub-functions, followed by an explanation of the contents of the relevant sub-function.

| | |
|---|---|
| Patients | |
| Selection | select a patient from a list |
| Viewing | view several images made of this patient |
| LV funct | |
| Draw | draw the contours of the cardiac wall (of the left ventricle or LV) |
| Segment | automatically determine the contours of the cardiac wall |
| Measure | calculate, on the basis of the contours, how well the left ventricle functions |
| Report | report the measuring results (for example, storage in file, printing) |
| RV funct | |
| Draw | draw the contours of the cardiac wall (of the right ventricle or RV) |
| Segment | automatically determine the contours of the cardiac wall |
| Measure | calculate, on the basis of the contours, how well the right ventricle functions |
| Report | report the measuring results (for example, storage in file, printing) |
| Perfusion | |
| Register | determine and correct motion of the heart in successive images |
| Draw | draw the contours of the cardiac wall (of the left ventricle or LV) |
| Segment | automatically determine the contours of the cardiac wall |
| Measure | calculate the quality of perfusion in the cardiac wall of the left ventricle |
| Report | report the measuring results (for example, storage in file, printing) |
| Coronary | |
| Track | automatically determine the track of a coronary artery |
| Measure | calculate the diameter of the coronary artery as a function of the location |
| Visualize | visualize the selected coronary artery (and possibly the measuring results) |
| Report | report the measuring results (for example, storage in file, printing) |
| Valves | |
| Movie | view the motion of the cardiac valves as a movie |
| Report | enter a diagnosis as a report by typing |
| | (for example, for taking up in file, printing). |

1. A user interface for the processing and presentation of image data, notably medical image data, which interface is arranged to co-operate with a database containing the image data, and a visual display unit and an input member that serves for communication with a user, characterized in that for each group of coherent image data of the data file the interface performs an image selection so as to present this selection to the display unit.

2. A user interface as claimed in claim 1, wherein the image data is combined with attribute data that is taken up in the database and characterizes a patient or the relevant image data, characterized in that the interface selects, in dependence on the attribute data, feasible applications for each group of coherent image data and separately adds a reference to every selected application to the image selection associated with the group of coherent image data for which the relevant application has been selected.

3. A user interface as claimed in claim 2, characterized in that it is arranged to add or remove an application selected by a user to or from an image selection.

4. A user interface as claimed in one of the claims 1 to 3, characterized in that it displays the feasible applications on the display unit and that, after selection of an application by a user, the interface performs a selection of every group of coherent image data that can be processed by the selected application and presents only the image selections that characterize this image data to the display unit.

5. A user interface as claimed in claim 4, characterized in that the interface shows the feasible sub-functions for each application and that each of these sub-functions can be individually selected by a user.

6. A user interface as claimed in one of the preceding claims, characterized in that the applications and/or sub-functions are adjustable in a desired processing order.

7. A medical analysis apparatus that is provided with a computer and a visual display unit coupled to the computer and an input member, characterized in that it includes a user interface as claimed in one of the claims 1 to 6.
